(19) United States
(12) Patent Application Publication
(10) Pub. No.: US 2016/0092979 A1
(43) Pub. Date: Mar. 31, 2016

(54) SYSTEM AND METHOD TO OPTIMIZE DISCOUNT SETTING UTILIZING FLEXIBLE PRICING AND CONTINUOUS PRODUCT TIME VALUE DECAY

(71) Applicants: Wouter Wolken, Chicago, IL (US); Jeroen Stedehouder, Chicago, IL (US)

(72) Inventors: Wouter Wolken, Chicago, IL (US); Jeroen Stedehouder, Chicago, IL (US)

(21) Appl. No.: 14/868,456

(22) Filed: Sep. 29, 2015

Related U.S. Application Data
(60) Provisional application No. 62/056,809, filed on Sep. 29, 2014.

(51) Int. Cl. G06Q 30/08; G06Q 30/06

(52) U.S. Cl. CPC G06Q 30/08; G06Q 30/0609

(57) ABSTRACT

A method and machine to provide a flexible pricing approach for one or more sellers and multiple buyers with a demand and time dependent real-time bid acceptance engine to work together to increase sales at optimal prices for both buyer and seller. Bids are accepted, by a machine comprising computing and comparative means as well as communication, fraud detection and manipulation parameters, at three potential moments in the process, at bid placement, between bid placement and auction end and at auction end. The acceptance threshold for bids is dependent on both time, demand and market volatility, but can be any combination of 2 or more. An auction will run between auction start and auction end and will only be prematurely terminated once supplies are depleted.

### CROSS-REFERENCE TO RELATED APPLICATIONS

This application claims the benefit of U.S. Provisional Application No 62/056,809, filed Sep. 29, 2014, entitled SYSTEM AND METHOD FOR IMPROVED ONLINE BIDDING, by the present inventors, which is incorporated by reference as set forth in full herein.

### BACKGROUND OF THE INVENTION

1. Field of the Invention

The present invention relates generally to systems and methods associated with the use and manipulation of machines, including computers, for commercial purposes, and more particularly to providing an improved system and method to optimize discount setting via a computer network.

2. Background of the Invention

Various systems and methods have been developed for the buying and selling of goods and/or services over the Internet. Although most of these systems and methods provide for a solution in conducting e-commerce transactions, many shortcomings still exist in the current space of e-commerce. These systems and methods can, generally speaking, be split up in a few separate classes.

One class of systems and methods are those selling goods and/or services against a fixed price during an extended period of time, such as ordinary web shops. The process of this conventional system and method of selling, hereinafter referred to as a “markdown process”, usually starts with offering the good and/or service at full price, followed by a time period in where the good and/or service is offered at a low discount, inventory permitting, followed by a time period in where the good and/or service is offered at a high discount, inventory permitting, followed by an eventual clearance and/or liquidation sale, inventory permitting, of the good and/or service. Although these conventional ways of selling goods and/or services have been the standard for many years, a few drawbacks still exist. One drawback stems from that fact that the “markdown process” happens in discrete steps, leading to suboptimal pricing of such goods and/or services, and a potential prolonged time during which these goods and/or services are sold either individually or collectively. This system and method of selling also does not engage the prospective buyer in the pricing aspect of the good and/or service, which could lead to a potential loss of sale as a result of the prospective buyer losing interest during the online purchasing process.

Another class of systems and methods are those selling goods and/or services against a fixed price during a short period of time, such as flash deal sites. This type of systems and methods often offer deep fixed discounts in order to generate sales. However, this system and method of selling lacks the ability to immediately adjust pricing of the goods and/or services based on direct supply and demand. As a result, this could lead to loss of sales or suboptimal pricing for which the goods and/or services are sold.

Another class of systems and methods are those selling goods and/or services at variable prices during a short period of time, such as auction sites, making offer platforms, flexible pricing platforms, etc. Auction sites as well as making offer platforms allow their prospective buyers to place a bid/make an offer on a variety of products during an allotted time period after which a winner is appointed. They lack the ability to establish a market price based on direct supply and demand for selling a multitude of goods and/or services from one or more sellers to multiple buyers. Also, there exists a lack of instant gratification as prospective buyers have to wait until the end of the allotted time period to find out whether or not they are the winner of the good and/or service. Usually, auction sites and making offer platforms focus on the second hand market, making it also hard for the buyer to validate the state of the second hand good. Flexible pricing platforms, just as auction sites and making offer platforms, lack the instant gratification aspect as these are primarily focused on matching one buyer, who inputs his/her own price, to one of the multiple sellers, who accept the buyer's own price.

This application describes a useful, creative, novel and unobvious invention of selling a plurality of a homogeneous good and/or service from one or more sellers to multiple buyers in a fully automated fashion. This method of selling has numerous advantages, the first advantage being that multiple prospective buyers have the ability to buy a quantity of one or more of the same good and/or service against flexible prices, where the acceptance threshold of these flexible prices are merely a reflection of time and the good's and/or service's direct demand. Here, the seller of the good and/or service sets the initial price variables, from which point the prospective buyer has complete control, within boundaries set by the seller, for which price he/she acquires the good and/or service. This manner of selling has a second advantage in that it saves the seller all of the work involved with the actual selling of the good and/or service as the seller doesn't need to execute any transactions or either reject/accept the flexible price submitted by the prospective buyer. The third advantage is that this system and method allows for instant gratification in one simple prospective buyer initiated transaction. Another advantage involves the rate at which a seller's inventory is cleared; selling a multitude of goods and/or services through flexible demand-driven pricing ensures price optimization of the goods and/or services at any time during the “markdown process,” resulting in the seller's inventory to be cleared at a much higher rate as opposed to any other traditional inventory clearing method. Also, a flexible demand-driven pricing system and method creates an interactive shopping experience for the prospective buyer; keeping the prospective buyer involved in the pricing process of a good and/or service leads to the generation of more sales as the probability of the prospective buyer completing the online purchasing process is much higher.

### SUMMARY OF THE INVENTION

In accordance with one embodiment this system and method of discount setting comprises an advanced bid filtering process, where a bid is stored at bid placement and can be accepted at any point in time between bid placement and auction end, this being dependent on a bid acceptance threshold based on, but not limited to, a complex combination of product value change over time, demand and supply, changing bidding patterns, and volatility of total placed bids.

In accordance with the present invention, a method and device for providing one or more sellers the ability to sell a plurality of homogeneous goods and/or services to multiple bidders is provided. It will be seen that in a preferred embodiment, the device and method comprise a machine comprising a central processing unit (CPU), rapid access memory (RAM), read only memory (ROM), a plurality of data storage locations, communications means, and peripherals, wherein the machine is capable of receiving and storing bids and their associated credit information. In the operation of the method and device, one or more bidders place bids on goods or services and inputs payment credentials into the machine whereupon each bid is stored in one of the plurality of data storage locations and the associated payment information is stored in a payment information detail storage location.

The invention provides real-time processing of bids to immediately accept or temporarily reject bids, storing of temporarily rejected bids in the one or more data storage locations and reconsidering temporarily rejected bids for acceptance at limited sequential time intervals until either inventory of offered goods or services are sold out or none of the limited sequential time intervals remain.

In preferred embodiments of the machine of the present invention there is included a fraud detection means for determining if the bid is a true independent bid, the fraud detection means being capable of terminating a bid if the bid is determined to be suspicious. In addition, it will be seen that the machine of the invention can be one or more machines.

So as to provide the best efficiency in action, the invention includes the ability to at the end of the bidding period, reconsider all temporarily rejected bids for acceptance using at least one of classification method and central tendency value. Additionally, the invention provides for the acceptance of a bid based on the product value decay over time, inventory availability of the good or service, and elasticity of demand. Further, the invention provides for the acceptance of the bid based on the elasticity of demand of the bids and volatility of total bids.

In preferred embodiments, the invention includes means to classify bids as live, temporarily rejected, or revived. It will be understood that in the invention the acceptance of a bid is dependent on 1) a complex varying combination of supply, demand (elasticity), demand volatility, product value decay over time or 2) a central tendency value method and/or a classification method. Further, for the convenience of participants in the process, in preferred embodiments a bidder places a bid using a price slider comprised of a range of acceptable prices having a pre-specified minimum price and a pre-specified maximum price.

In some embodiments of the invention operators of the invention can provide a standalone software system for use in a third party merchant/supplier/e-commerce website as an embedded additional feature of the website. In addition, the device and method can be can be configured for use in brick & mortar stores, through mobile applications and mobile web portals.

In preferred embodiment, bidders have the option to increase the value of a temporarily rejected bid during the bidding period. It will be understood that in the invention a price of a good or a service follows a non-linear product value decay over time.

For the convenience of the users, in preferred embodiments of the invention payment information is one or more of credit card information, bank routing and account information, PayPal® account information or other third party payment service information.

In some embodiments, the invention provides a method and device for storing a bidder's payment credentials at bid placement and paying a seller therefrom at the conclusion of an auction, the auction involving at least one seller and at least one buyer, the device and method using the payment credentials to debit the bidder's account after the seller's bid has been accepted, the methods and device acting at any point in time after the placement of a bid. The invention can provide for a means for calculating and displaying the probability of a bidder winning an auction at the bidder's bid price, so as to encourage the bidder to adjust the bid to register a higher probability of winning the auction.

### Advantages

Accordingly several advantages of one or more aspects are as follows: to provide a flexible pricing model with bid storage functionality that is able to sell a plurality of homogeneous new, excess or out of season goods and/or services to multiple buyers within the shortest possible time frame against the most optimal prices, that allows the “markdown process” to be continuous, that allows instant gratification, and that is fully automated with regard to bid and payment processing. Other advantages of one or more aspects will be apparent from a consideration of the drawings and ensuing descriptions.

### BRIEF DESCRIPTION OF THE DRAWINGS

FIG. 1 is a block diagram illustrating the configuration of an embodiment of a system and method according to the present invention;

FIG. 1A is a schematic representation of a machine designed to host much of the system and method shown in FIG. 1;

FIG. 2 is a block diagram illustrating the process executed upon user bid submission;

FIG. 3 is a block diagram illustrating the system component causing non-linear product value decay over time;

FIG. 4 is a block diagram illustrating the process executed during the auction period for reconsidering temporarily rejected bids for possible acceptance;

FIG. 5 is one embodiment of a process executed at auction end for reconsidering temporarily rejected bids for possible acceptance;

### DETAILED DESCRIPTION OF THE ILLUSTRATIVE EMBODIMENT

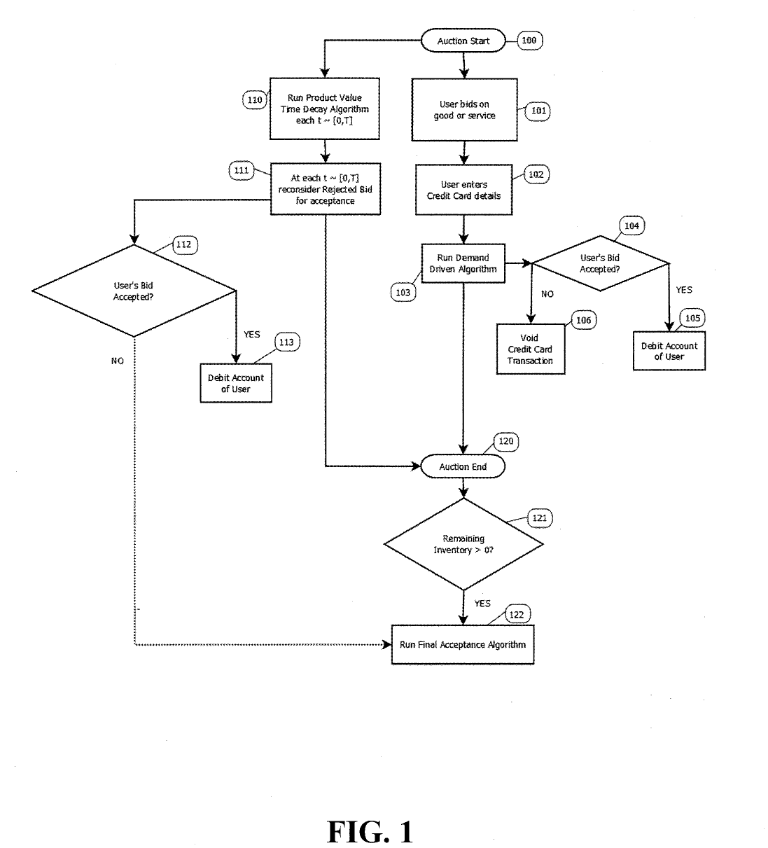

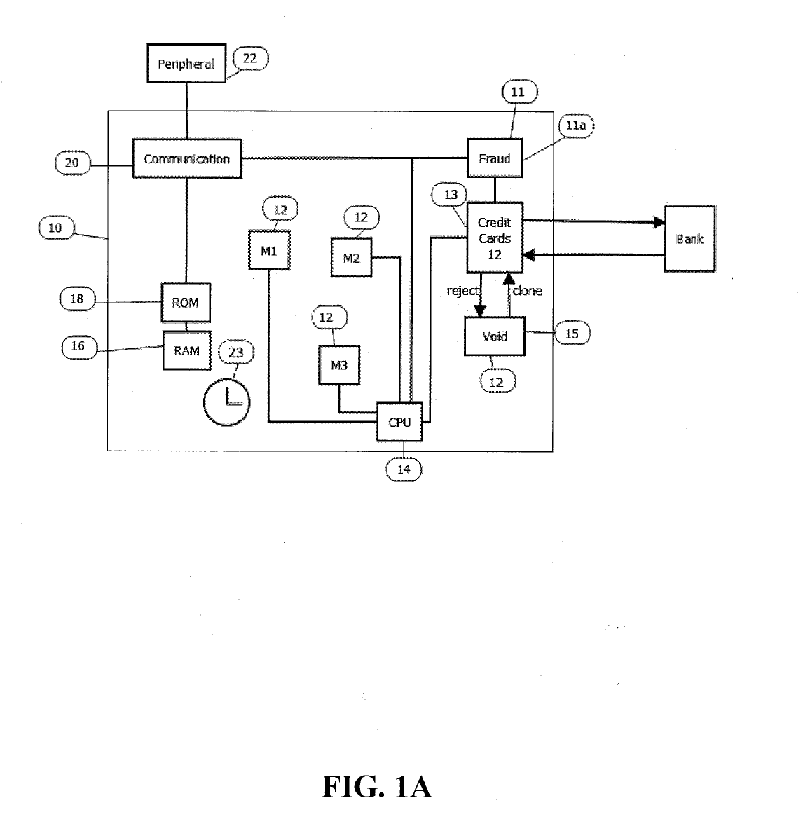

Referring now to FIGS. 1-5, exemplary embodiments of an improved system and method to optimize discount setting are shown. In these exemplary embodiments, optimization of discount setting is achieved through a process of accepting bid prices from multiple users only above a certain demand and time dependent intelligent bid acceptance threshold.

FIG. 1 is a block diagram illustrating the configuration of an embodiment of an improved system and method according to the present invention. An auction is started in block 100. Multiple users may provide a bid, through an online graphical user interface, on a certain good and/or service, as shown in block 101. For direct settlement of the bid a user's payment credentials are needed, by way of example, in the form of credit card details, as shown in block 102. To allow for potential direct acceptance of a user's bid the demand driven algorithm is automatically triggered as shown in block 103. Depending on the result of the demand driven algorithm, the bid may be either accepted or temporarily rejected, as shown in block 104. If a bid is accepted, a credit card transaction will be executed and submitted for settlement in order to debit the user's account instantaneously, as shown in block 105. If a bid is temporarily rejected, block 106 will void the executed credit card transaction and save the credit card details as this temporarily rejected bid will be reconsidered for acceptance at a limited number of time intervals during the auction, and once more at auction end if bid was not accepted during the auction period. When accepted, the voided credit card transaction will be cloned and submitted for settlement.

Parallel to this filtering process runs block 110; at each time interval t, where t is uniformly distributed over the time between auction start and auction end, the product value time decay algorithm is run to account for product value decay over time. Block 111, retrieves all previously temporarily rejected bids, and reconsiders it for acceptance at every time interval t as shown in block 112. If the previously temporarily rejected bid is deemed acceptable, the previously voided credit card transaction is cloned and submitted for settlement in order to debit the account of the user whose bid got accepted, as shown in block 113. Block 120 signals the end of the auction period. Block 121 checks if any temporarily rejected bids remain and if there is inventory of the given good and/or service still available. If both conditions hold true, block 122 will be triggered to do an optional final review of the temporarily rejected bids, and possibly accept some or all of these based on the result of the statistical final acceptance formula.

Referring now to FIG. 1A, it can be seen that a specific embodiment of a machine 10 is shown as having the capability to run the system and method of the present invention. Machine 10 in a preferred embodiment includes a number of memory storage locations 12 that are capable of storing data, moving data in and out of storage locations, comparing data and allowing the data to be manipulated and then stored again, moved and/or compared. Machine 10 further comprises a central processing unit (CPU) 14, rapid access memory (RAM) 16 and read only memory (ROM) 18. Communications means 20 is provided to allow machine 10 to transact with bidders, banking systems, credit card systems, networks and peripheral devices 22, such as printers and data entry devices. In the operation of the system and method, such items as bids can be received with the communications means 20 or through peripheral connectivity and stored in one memory storage location 12 and its concomitant payment information, in preferred embodiments card data, can be placed in a separate memory location 12 specifically nominated for live payment/credit details 13.

It will be understood that the system and method are directed to multiple bids being accepted over time and being sorted, analyzed and stored in the manner noted in this disclosure, for clarity, while the description may discuss a particular bid at a particular time, it will be understood that the illustration here is just for clarity and that each bid may be accepted, may be temporarily rejected, thus stored for further analysis (in accordance with the teachings of the invention) and that bids that have been temporarily rejected can be revived, reanalyzed, restored and re-rejected throughout the process described herein. As time, t, progresses, as determined by machine 10 clock 23, any bid, having been entered and stored in a memory 12, can be moved to another memory storage location 12, can be designated by machine 10, as being a temporarily rejected bid. Temporarily rejected bids, those that currently do not qualify as being in a position to purchase goods or services compared to other bids received with greater value (live bids), remain stored and are reviewed by CPU 14 to determine, using software in ROM 18, whether the temporarily rejected bid becomes valid after the passage of a determined time t, due to the automatic decline of product value over time, additional product or service being available or a decrease in product demand by consumers.

When a bid is considered temporarily rejected the concomitant credit card data is moved from the live credit details storage 13, the storage location of credit information associated with live bids, to a voided credit details storage 15, where it is maintained in a voided credit state unless the temporarily rejected bid becomes a live bid as described above. The machine 10 provides a continuous review and movement of details such that bids can be live (accepted) and temporarily rejected to coincide with the amount of the bid, the present value of the goods or services, the present demand of the goods or services and the supply of goods or services.

As will be described in more detail below, machine 10 will be instrumental in taking data from the input of the seller of products and details and bidders and will compare the data against itself and preceding and subsequent bids, stock, product or service demand, present product or service value, and other conditions of sales, clock the data to determine chronological changes in conditions, move data from position to position to maintain the data's relevance and its associated purchase information; determining from time to time the creation of a sale, the voiding of a bid and the review of temporarily rejected bids to determine if the temporarily rejected bid with time can be a live bid and create sales. The machine, through its peripherals 22 and communication means 20 can then consummate sales and provide receipts and notifications of purchase to the successful bidders. In addition, in some embodiments, the machine 10 can include such peripherals 22 as packaging and mailing devices, return authorization generators, shelving machinery and others that further automate the sales process.

In a preferred embodiment of the machine 10, fraud detection device 11 is provided by providing a fraud storage location 11a into which each bid, or a copy of each bid, and credit information is stored and compared to all other bids and credit information, address, zip code, membership numbers (where applicable) and all other data provided by bidders. Upon comparison, coincidental identical data between bids can be flagged for further review to determine if multiple bids are coming from a single source and to otherwise check for fraudulent activity by one or more bidders. Fraud detection device 11 works by using the power of the CPU 14, RAM 16 and communications means 20 to check the veracity of the data provided by bidders.

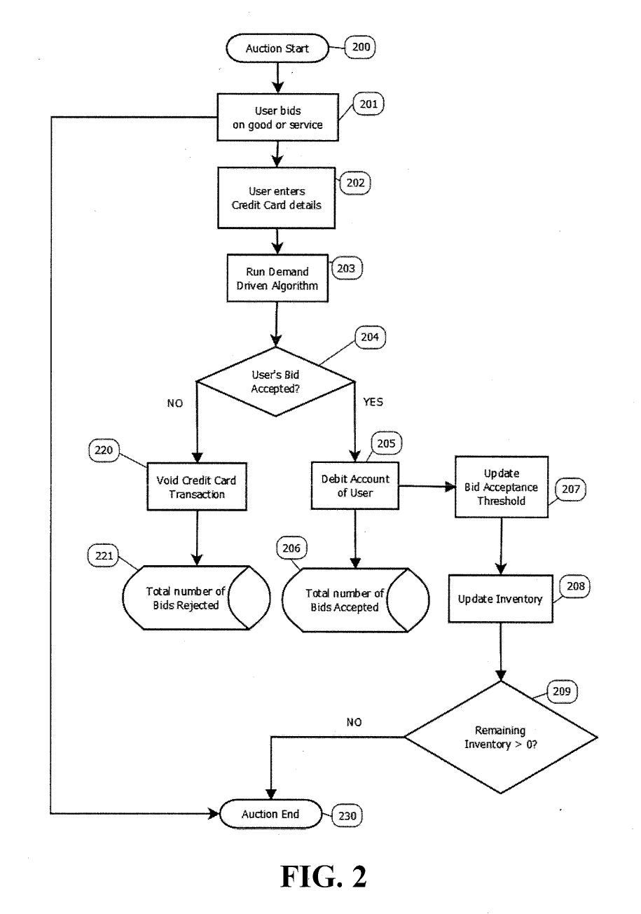

FIG. 2 is a block diagram of a detailed embodiment of the process executed upon user bid submission between auction start and auction end. As illustrated in the embodiment of FIG. 2, an auction starts, as shown in block 200. Multiple users may place a bid, through an online graphical user interface, on a certain good and/or service, as shown in block 201. For real-time processing of the bid, a user's payment credentials are needed, by way of example, in the form of credit card details, as shown in block 202. To allow for real-time acceptance of a user's bid the demand driven algorithm is automatically triggered as shown in block 203. The demand driven algorithm decides, based on market demand, product value over time, and product market volatility, whether or not a bid gets accepted. A general overview of how the demand driven algorithm works is provided below, but can be substituted by any statistical or intelligent system:
1. Retrieve the “bid acceptance threshold,” if available. Else, set default value.
2. Retrieve all bids (set B).
3. Split bids into two subsets C & D, using an arbitrary split variable x:
   a. Create a set C ⊂ B, such that C={Cᵢ|Cᵢ≦(1+x)pMin}∀i
   b. And create a set D ⊂ B, such that D={Dᵢ|Dᵢ>(1+x)pMin}∀i
   c. Calculate the sample standard deviation of set C, D, i.e., σ_{c}, σ_{d}, respectively:

$${σ}_{x} = \sqrt{\frac{1}{N - 1} {\sum }_{i = 1}^{N} {( {bid}_{i , x} - μ )}^{2}}$$

$${μ}_{x} = \frac{1}{N} {\sum }_{i = 1}^{N} {bid}_{i , x}$$

d. Calculate the equal weighted volatility:

$$σ = \frac{{σ}_{c} + {σ}_{d}}{2} ,$$

when both are non-defined or zero, take default value

$$σ = \frac{p Max}{10 {S}_{fac}}$$

4. Calculate the exponentially weighted demand elasticity of the current bid:

$${e}_{t} = {ωe}_{t - 1} + ( 1 - ω ) ( \frac{{Qty}_{bid}}{{Q}_{old}} / \frac{- abs ( {bid}_{t} - {P}_{decay , t} )}{{P}_{decay , t}} )$$

$${P}_{decay , t} = Product Value Decay over Time$$

$${Qty}_{bid} = Bidded Quantity$$

$$ω = arbitrary chosen weighing value$$

5. If the current bid is equal or greater than the “bid acceptance threshold,” calculate the new demand pull price using the exponentially weighted demand elasticity:

$${Dp}_{j} = {P}_{decay , t} + \frac{{P}_{decay , t} - {Qty}_{offer}}{{e}_{t} * {Q}_{old}}$$

$${Q}_{old} = available inventory before offer acceptance$$

$${dPrice}_{t} = \frac{1}{j} {\sum }_{i}^{j} {Dp}_{j}$$

6. Use classification algorithm to perform a double check using verified training data. An example algorithm (simplified) is:
   a. Standardize bid, time and training data to be of scale [0,1] by dividing by pMax, Tₘₐₓ and Scale_{training}, where latter is proportional to pMax and Tₘₐₓ.
   b. Choose or optimize number of nearest neighbors K.
   c. Calculate Euclidian Distance between bid and training data points:

EDₜ=\sqrt{(time_{training,t}−time_{bid,t})²+(Value_{training,t}−Bidₜ)²}
d. Sort on EDₜ, choose K smallest EDₜ values, and sum the sign of the respective data points of the smallest K EDₜ values. Sign is −1 (not accepted) and sign is +1 (accepted). If sum(signs)>0 then accept bid, if sum(signs)≦0 then reject bid.
   e. Update training data with newly obtained data point.
7. If classification algorithm accepts bid and if bid≧“bid acceptance threshold,” the bid is accepted, followed by updating the “bid acceptance threshold,” using the market volatility, demand pull price, and product value time decay:

$${Accept}_{t + 1} = ( 1 - υ ) [ \frac{{P}_{decay , t} + {dPrice}_{t}}{2} - {S}_{fac} * min ( 0.3 * \frac{pMax}{{S}_{fac}} , max ( \frac{{P}_{decay , t}}{10 {S}_{fac}} , σ ) ) ]$$

Block 204 communicates the result of block 203 back to the user through a graphical user interface. If the bid is accepted, the credit card transaction will be executed and submitted for settlement in order to debit the account of the user instantaneously, as shown in block 205. The accepted bid will automatically be stored in a database as shown in block 206. Block 207 shows the formality of updating the “bid acceptance threshold” using the method described in block 203. To ensure the market is still viable, block 208 shows the process of updating the inventory level by subtracting the accepted bid quantity from the initial inventory available before the bid got accepted. If the inventory is depleted, block 209 shows the process of closing the auction prematurely due to lack of inventory.

If a bid is temporarily rejected, block 220 will void the executed credit card transaction and save the credit card details, as this temporarily rejected bid will be reconsidered for acceptance at a limited number of time intervals during the auction, and once more at auction end if bid was not accepted during the auction period. Block 221 shows the automatic storage of a temporarily rejected bid in a database for later use. Block 230 signals the end of the auction period.

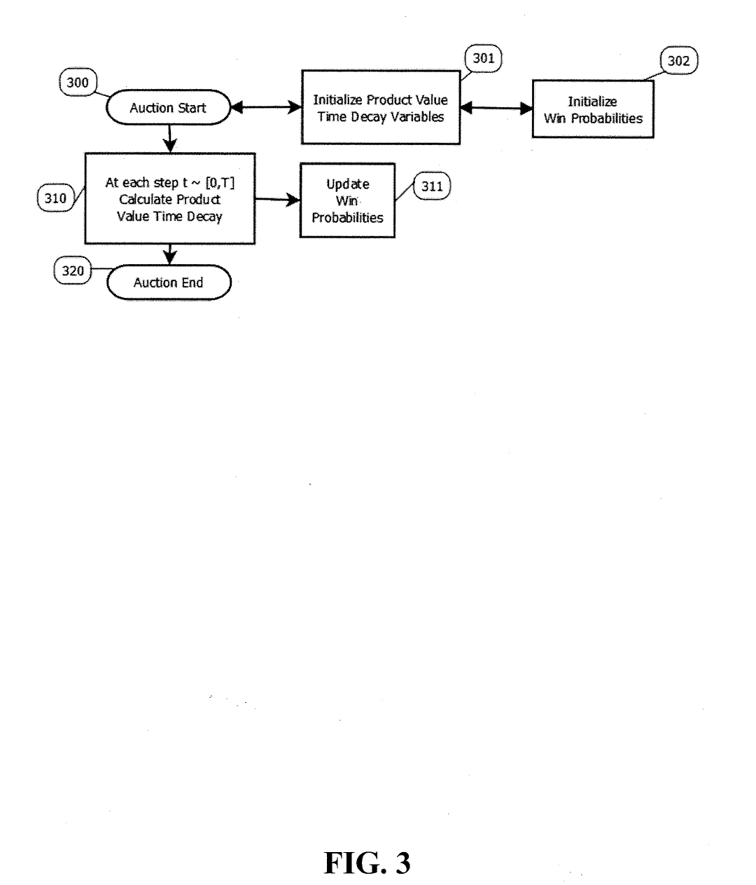

FIG. 3 is a block diagram of a detailed embodiment of the system component causing non-linear product value decay over the time period between auction start and auction end. As illustrated in the embodiment of FIG. 3, an auction begins, as shown in block 300. Block 301 shows the initialization of the product value time decay algorithm variables to ensure time follows a non-linear decay function. These steps are followed:
1. Choose a product value decay amount (D^{A}).
2. Set product value time decay equal to pMax, the maximum price of the product:

P_{decay,0}=pMax
3. Solve for a optimal time volatility to account for optimized time value decay:

$${D}^{A} = ( pMax - {D}^{A} ) N ( d 1 ) - ( pMax - {D}^{A} ) N ( d 2 ) , \\ τ = {T}_{max} - {T}_{0} = auction time$$

$$d 1 = \frac{0.5 {σ}^{2} τ}{σ \sqrt{τ}}$$

$$d 2 = d 1 - σ \sqrt{τ}$$

N(x) is the cumulative standard normal distribution.
4. At each successive time interval (hour/minute/second) until auction end calculate product value time decay:

$${P}_{decay , t} = {P}_{decay , t - 1} + \frac{S ϕ ( d 1 ) σ}{2 \sqrt{τ}} , \\ τ = \frac{{T}_{max} - t}{( {T}_{max} - {T}_{0} )}$$

φ(x) is the standard normal probability density function.

The calculation of product value time decay is not limited to this specific method or model; it can be substituted by any other non-linear method or model.

Block 310 illustrates step 4 of the product value time decay algorithm, where product value time decay is adjusted to take into account the current most optimal product value time decay. Using updated product value time decay, update the probability of a bid getting accepted, hereinafter referred to as “win probabilities,” these being initialized in block 302, in order to encourage users to bid in line with the market, as shown in block 311, as follows:
1. Retrieve new product value time decay.
2. Calculate probabilistic distance between potential bid and product value time decay:

$${Prob}_{dist , bid , t} = ln ( \frac{{P}_{decay , t}}{Bid} )$$

3. Convert distance into probability using a lognormal cumulative distribution function; any method or distribution can be substituted:

$${Prob}_{win , bid , t} = \frac{abs ( {Prob}_{dist , bid , t} ) + ( \frac{{σ}_{bids}^{2}}{2} ( {T}_{max} - t ) )}{{σ}_{bids} \sqrt{{T}_{max} - t}}$$

$${σ}_{bids} = sample standard deviation of all placed bids$$

$${T}_{max} = auction end time point$$

4. Display probabilities through a graphical user interface.

Block 320 signals the end of the auction period.

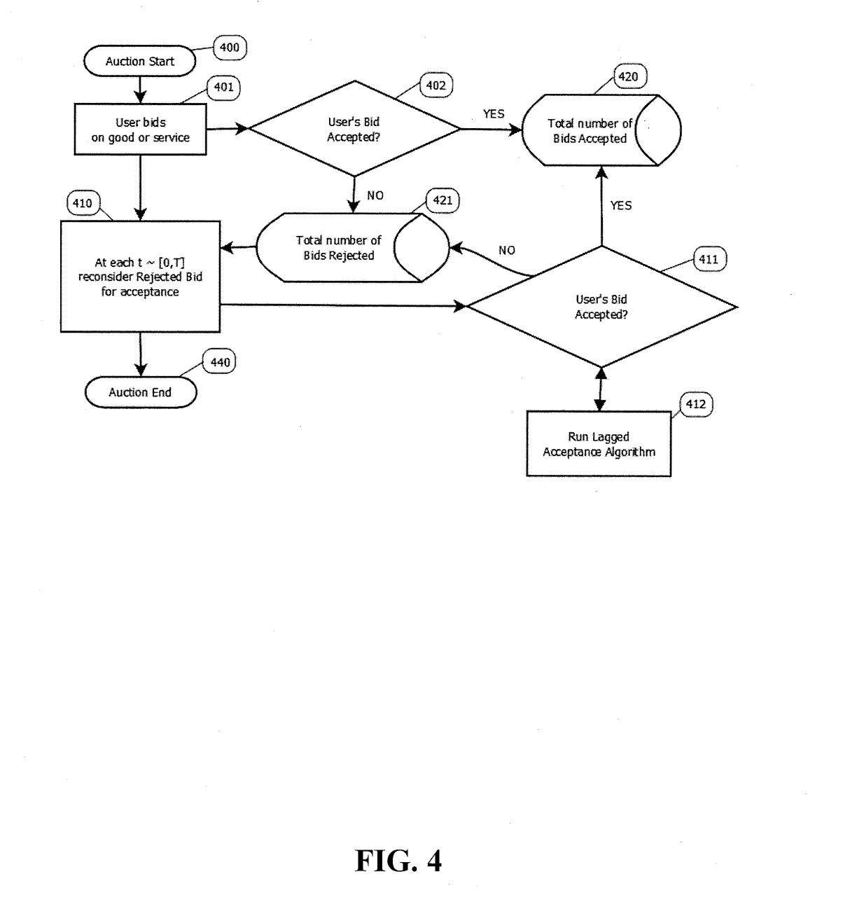

FIG. 4 is a block diagram of a detailed embodiment illustrating the process executed during the auction period for reconsidering temporarily rejected bids for possible acceptance. As illustrated in the embodiment of FIG. 4, an auction begins, as shown in block 400. Multiple users may submit a bid on a given good and/or service through a graphical user interface, as shown in block 401. Block 402 illustrates the result of the demand driven algorithm; if the bid is accepted, the bid is stored in a database, as shown in 420. If the bid is temporarily rejected, the bid will be stored in another database, as shown in block 421, and will be reconsidered for acceptance at a limited number of time intervals during the auction, and once more at auction end if bid was not accepted during the auction period. Block 410 retrieves previously temporarily rejected bids from the database shown in 421, and the lagged acceptance algorithm is run checking at every time interval t if a previously temporarily rejected bid could possibly still get accepted, as shown in 411, using the following steps, as shown in 412:
1. Retrieve the “bid acceptance threshold,” if available. Else, set default value.
2. Run bid through classification algorithm, for example:
   a. Standardize bid, time and training data to be of scale [0,1] by dividing by pMax, Tₘₐₓ and Scale_{training}, where latter is proportional to pMax and Tₘₐₓ.
   b. Choose or optimize number of nearest neighbors K.
   c. Calculate Euclidian Distance between bid and training data points:

EDₜ=\sqrt{(time_{training,t}−time_{Bid,t})²+(Value_{training,t}−Bidₜ)²}
d. Sort on EDₜ, choose K smallest EDₜ values, and sum the sign of the respective data points of the smallest K EDₜ values. Sign is −1 (not accepted) and sign is +1 (accepted). If sum(signs)>0 then accept bid, if sum(signs)≦0 then reject bid.
   e. Update training data with newly obtained data point.
3. If bid ≧“bid acceptance threshold,” and classification algorithm accepts bid:
   a. Retrieve all bids (set B).
   b. Split bids into two subsets C & D, using an arbitrary split variable x:
      i. Create a set C ⊂ B, such that C={Cᵢ|Cᵢ≦(1+x)pMin}∀i
      ii. And create a set D ⊂ B, such that D={Dᵢ|Dᵢ>(1+x)pMin}∀i
      iii. Calculate the sample standard deviation of set C, D, i.e., σ_{c}, σ_{d}, respectively:

$${σ}_{x} = \sqrt{\frac{1}{N - 1} {\sum }_{i = 1}^{N} {( {bid}_{i , x} - μ )}^{2}}$$

$${μ}_{x} = \frac{1}{N} {\sum }_{i = 1}^{N} {bid}_{i , x}$$

iv. Calculate the equal weighted volatility:

$$σ = \frac{{σ}_{c} + {σ}_{d}}{2} ,$$

when both are non-defined or zero, take default value

$$σ = \frac{p Max}{10 {S}_{fac}}$$

c. Calculate the updated exponentially weighted demand elasticity of the current bid:

$${e}_{t} = ω {e}_{t - 1} + ( 1 - ω ) ( \frac{{Qty}_{bid}}{{Q}_{old}} / \frac{- abs ( {bid}_{t} - {P}_{decay , t} )}{{P}_{decay , t}} )$$

$${P}_{decay , t} = Product Value Decay over Time$$

$${Qty}_{bid} = Bidded Quantity$$

$$ω = arbitrary chosen weighing value$$

d. Calculate the new demand pull price using the exponentially weighted demand elasticity:

$${Dp}_{j} = {P}_{decay , t} + \frac{{P}_{decay , t} - {Qty}_{offer}}{{e}_{t} * {Q}_{old}}$$

$${Q}_{old} = available inventory before offer acceptance$$

$${dPrice}_{t} = \frac{1}{j} {\sum }_{1}^{j} {Dp}_{j}$$

e. Update the “bid acceptance threshold,” using the market volatility, demand pull price, and product value time decay:

$${Accept}_{t} = ( 1 - υ ) [ \frac{{P}_{decay , t} + {dPrice}_{t}}{2} - {S}_{fac} * min ( 0.3 * \frac{pMax}{{S}_{fac}} , max ( \frac{{P}_{decay , t}}{10 {S}_{fac}} , σ ) ) ]$$

If the previously temporarily rejected bid gets accepted, it will be stored in the database as shown in block 420. If the previously temporarily rejected bid gets temporarily rejected again, it will remain in the database of temporarily rejected bids as shown in block 421. Block 440 signals the end of the auction period.

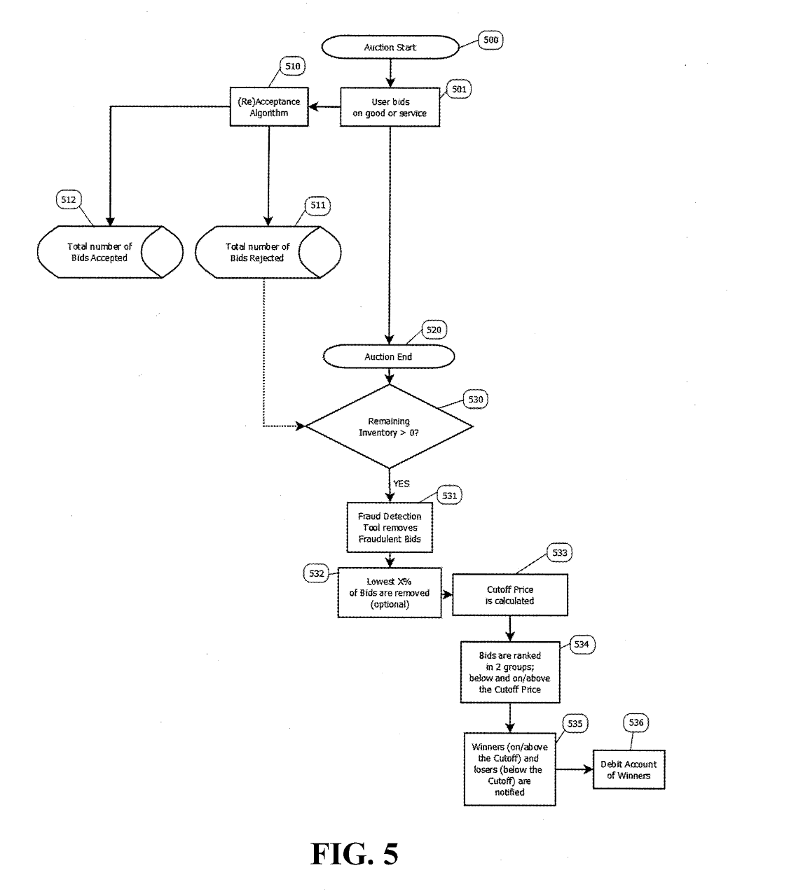

FIG. 5 is a block diagram of a detailed embodiment illustrating the process executed at auction end for reconsidering temporarily rejected bids for possible acceptance. As illustrated in the embodiment of FIG. 5, an auction begins, as shown in block 500. Multiple users may provide a bid, through an online graphical user interface, on a certain good and/or service, as shown in block 501. Block 510 shows the “(Re)Acceptance Algorithm,” which is combination of the demand driven algorithm run upon user bid submission, and the lagged acceptance algorithm, run at every time interval t. The resulting bids from 510 are split up in two databases; one database for the temporarily rejected bids 511, one database for the accepted bids 512. If at auction end temporarily rejected bids still remain, they will be transferred to the process shown in block 530.

Block 520 signals the end of the auction period, if there is still inventory available, returned by the process shown in block 530, a fraud detection tool 531 removes any fraudulent bids from the total pool of temporarily rejected bids 511. The fraud detection tool 531 flags previously temporarily rejected bids for an administrator of the bidding system. The fraud detection tool 531 can be implemented through a series of checks on a user's payment credentials. By way of example, a credit card vendor may typically return the first six digits and the last four digits of a credit card number to the bidding systems for storage within the bidding system's database. If a user places a bid in block 501 of the bidding process for a particular auction, and that user's payment credentials are stored within the bidding system, and if a different user places a bid in block 501 of the bidding process for the same auction, the fraud detection tool 531 will compare the first six and last four digits of the credit card number of the first user to the first six and last four digits of the credit card number of the second user; if there is a match, the fraud detection tool 531 will throw a flag on both bids.

Additionally, further identifying information, such as a billing ZIP code, billing address, or other billing information can be used to compare multiple users in a single auction. If matches are found on this identifying information on multiple bids, it raises the likelihood of fraud occurring in a particular auction. Additionally, the fraud detection tool 531 can flag a certain subset of bids on a particular auction when more than a certain percentage of the bids on a particular auction are in a lower pre-specified percentile of the entire range of bids on the good and/or service in that particular auction. By way of example, a fraud flag can be raised and delivered to an administrator of the bidding system when more than 50% of the bids on a particular auction are in the lowest 20% of the price range of that auction. This is shown in block 532.

After the fraud protection tool 531 is run on the total pool of temporarily rejected bids 511, a cutoff price is calculated by a statistical method based on, but not limited to, an average, median and/or a certain top percentage of the total pool of bids 511, minus any bids removed by the fraud detection tool 531, as shown in block 533. An example statistical method (“Method I”) to calculate the cutoff price can be, but is not limited to:
Accumulate all Temporarily rejected Bids B ∈ [pMin, pMax]
Where pMin is the minimum price that can be submitted; and
pMax is the maximum price that can be submitted.
   a. Calculate the mean (μ) price of all temporarily rejected Bids B:

$${B}_{μ} = \frac{1}{m} {\sum }_{i = 1}^{m} {B}_{i}$$

b. Calculate the standard deviation (a) of all temporarily rejected Bids B:

$${B}_{σ} = \sqrt{\frac{1}{m} {\sum }_{i = 1}^{m} {( {B}_{i} - μ )}^{2}}$$

c. Calculate the lower bound as: LB=max[pMin*(1+R), (μ−σ)]
   d. Calculate the upper bound as: UB=min[pMax*(1−R), (μ+σ)] Where R is a random number R˜U([X,Y])
   e. Create a set C ⊂ B, such that C={Cᵢ|Cᵢ≧LB, Cᵢ≦UB}∀i
   f. IF [C={ }→C*=(Cᵢ|Cᵢ≧LB, Cᵢ≦pMax}∀i]
   g. Calculate the mean (μ) price of all Bids C:

$${C}_{μ} = \{ \begin{matrix}pMax & if {C}^{*} = \{ \} \\ \frac{1}{m} {\sum }_{i = 1}^{m} {C}_{i} & if C , {C}^{*} \neq \{ \}\end{matrix}$$

h. Create a winning set W ⊂ B, such that W={Bᵢ|Bᵢ≧C_{μ}}∀i
   i. ONE-TIME-ITERATION ONLY: IF [W=B→UB=pMax]→Repeat steps (e) through (h).
   j. Create a losing set L ⊂ B, such that L={Bᵢ|Bᵢ<C_{μ}}∀i

Two sets of bids are created: a winning set containing bids on or above the cutoff price, and a losing set containing bids below the cutoff price, as shown in block 534. In block 535, the bidding system notifies the users belonging to each bid in each set (winning or losing) accordingly, through a communication means such as, but not limited to, email or text message. The bidding system then proceeds to debit the payment accounts of the users in the winning set, as shown in block 536.

Although the description above contains many specifics, these should not be construed as limiting the scope of the embodiments but as merely providing illustrations of some of several embodiments. For example, the system can also be applied to an online marketplace where an auction is not preferred; a changing BUY NOW price is also extremely competitive and engages prospective buyers on a daily, hourly or even shorter time period basis. Furthermore, the system can also be applied outside of e-commerce, using a mobile website or mobile application to enable instant gratification when a prospective buyer places a bid while physically being present inside or near a brick and mortar store. The system does also not depend on the different algorithms presented, for example, instead of a classification algorithm to decide if a bid is acceptable, a neural network can be used. Furthermore, different approaches to prospective buyer demand impact can be used; instead of demand elasticity one can model the demand peaks over time leading to a change in the bid acceptance threshold. Indeed, it will be understood that while formulas and algorithms are mentioned and employed, the invention should be viewed also for the movement of data and payment information within a machine that does many steps to compare, choose, vet, store and many other functions that are beyond an abstract idea or formula.

It is contemplated that the parts and features of any one of the embodiments described can be interchanged with the parts and features of any other of the embodiments without departing from the scope of the present disclosure. The foregoing description discloses and describes merely exemplary embodiments of the present disclosure and is not intended to be exhaustive or to limit the disclosure to the precise form disclosed. As will be understood by those skilled in the art, the disclosure may be embodied in other specific forms, or modified or varied in light of the above teachings, without departing from the spirit, novelty or essential characteristics of the present disclosure. Accordingly, the scope of the embodiments should be determined by the appended claims and their legal equivalents, rather than by the examples given.

### Conclusion, Ramifications and Scope

Accordingly, the reader will see that the flexible pricing model of the various embodiments, as used with the machine disclosed, can be used to sell, through a continuous “markdown process” over time, a plurality of homogeneous goods and/or services from one or more sellers to multiple buyers at (an) optimized price(s). Furthermore, the flexible pricing model is fully automated with regard to bid and payment processing, saving the supplier of the good and/or service time and money. In addition, the flexible pricing model allows for instant gratification to exist as the flexible pricing model allows for real-time bid processing, thereby either accepting or rejecting the bids directly after the submission thereof. Furthermore, the approach has additional advantages in that:
A potential buyer's temporarily rejected bid is stored, in one of a number of storage locations—having been vetted against fraud and other details, up until a pre-specified point in time, allowing the temporarily rejected bid to be reconsidered for acceptance once the bid acceptance threshold is in line with the temporarily rejected bid.
The seller obtains superior pricing data for future sales generation.
The seller does not have to individually accept or reject each placed bid.
Sellers do not influence price setting of the goods and/or services, leading to a market where pricing is demand driven.
Prospective buyers have an interactive shopping experience, where each buyer is involved in the process of setting their own price for the good and/or service and simultaneously having an influence on the price acceptance threshold thereof.
Displaying “win probabilities” as a visual guide to prospective buyers leads to competitiveness in a demand driven market where prospective buyers are less concerned with the right price and more focused on the probability of beating other prospective buyers.
Real-time bid processing makes instant gratification possible, while maintaining the integrity of the sale through checking and fraud review.

What is claimed is:

1. A method and device for providing one or more sellers the ability to sell a plurality of homogeneous goods and/or services to multiple bidders, comprising:
a. a machine comprising a central processing unit (CPU), rapid access memory (RAM), read only memory (ROM), a plurality of data storage locations, communications means, and peripherals, wherein the machine is capable of receiving and storing bids and their associated credit information,
b. one or more bidders placing bids on goods or services and inputting payment credentials into the machine whereupon each bid is stored in one of the plurality of data storage locations and the associated payment information is stored in a payment information detail storage location,
c. real-time processing of bids to immediately accept or reject bids, and
d. storing of temporarily rejected bids in the one or more data storage locations and reconsidering temporarily rejected bids for acceptance at limited sequential time intervals until either inventory of offered goods or services are sold out or none of the limited sequential time intervals remain.

2. The invention of claim 1, wherein the machine includes a fraud detection means for determining if the bid is a true independent bid, the fraud detection means being capable of terminating a bid if the bid is determined to be suspicious.

3. The invention of claim 1, wherein the machine is one or more machines

4. The invention of claim 1, wherein at the end of the bidding period, all temporarily rejected bids are reconsidered for acceptance using at least one of classification method and central tendency value.

5. The invention of claim 1, wherein the acceptance of a bid is solely based on the product value decay over time, inventory availability of the good or service, and elasticity of demand.

6. The invention of claim 1, wherein the acceptance of the bid is based on the elasticity of demand of the bids and volatility of total bids.

7. The invention of claim 1, wherein the method includes means to classify bids as live, temporarily rejected, or revived, among others into a classification method and the acceptance of the bid is primarily based on the classification method.

8. The invention of claim 1, wherein the acceptance of a bid is primarily based on the central tendency value of all the bids.

9. The invention of claim 1, whereby a bidder places a bid using a price slider comprised of a range of acceptable prices having a pre-specified minimum price and a pre-specified maximum price.

10. The invention of claim 1, further comprising a standalone software system for use in a third party merchant/supplier/e-commerce website as an embedded additional feature of the website.

11. The invention of claim 1, wherein the device and method are configured for use in brick and mortar stores, through mobile applications and mobile web portals.

12. The invention of claim 1, wherein the bidders have the option to increase the value of a temporarily rejected bid during the bidding period.

13. The invention of claim 1, whereby a price of a good or a service follows a non-linear product value decay over time.

14. The invention of claim 1, wherein payment information is one or more of credit card information, bank routing and account information, PayPal® account information or other third party payment service information.

15. The invention of claim 1, wherein providing mandatory payment information is not needed to place a bid.

16. A method and device for providing a means for storing a bidder's payment credentials at bid placement and paying a seller therefrom at the conclusion of an auction, on an auctionable good or service during an auction, the auction involving at least one seller and at least one buyer, the device and method using the payment credentials to debit the bidder's account after the seller's bid has been accepted, the methods and device acting at any point in time after the placement of a bid.

17. A method and device for providing a means for calculating and displaying the probability of a bidder winning an auction at the bidder's bid price, so as to encourage the bidder to adjust the bid to register a higher probability of winning the auction.
